(19) United States
(12) Patent Application Publication
(10) Pub. No.: US 2013/0199880 A1
(43) Pub. Date: Aug. 8, 2013

(54) METHOD FOR PRODUCING A BRAKE LINING CARRIER

(71) Applicant: Thomas Jancer, Olfen (DE)

(72) Inventor: Thomas Jancer, Olfen (DE)

(73) Assignee: RM BELAGTRAEGER GMBH, Bochum (DE)

(21) Appl. No.: 13/811,033

(22) PCT Filed: Feb. 25, 2011
(86) PCT No.: PCT/EP2011/000929

§ 371 Date: Apr. 3, 2013

(30) Foreign Application Priority Data
Jul. 21, 2010 (DE) 10 2010 031 889.2

(51) Int. Cl. F16D 65/092

(52) U.S. Cl. CPC F16D 65/092
USPC 188/250 B; 72/347; 72/340

(57) ABSTRACT

The invention relates to a method for producing a brake lining carrier (1, 10), in particular for a disc brake of a vehicle, wherein a band-shaped or plate-shaped workpiece is deep-drawn in a direction perpendicular to the plane of the workpiece. In order to create at least one material thickening at the edge, the invention proposes that the workpiece is upset transversely, in particular perpendicularly, to the deep-drawing direction, wherein the thickness of the material thickening thus generated is greater than the thickness of the starting material.

The invention relates to a method for producing a brake lining carrier, in particular for a disc brake of a vehicle, wherein a band-shaped or plate-shaped workpiece is deep-drawn in a direction perpendicular to the plane of the workpiece. The invention furthermore relates to a brake lining carrier as well as to a machining device, in particular to a forming tool, for executing the said method.

A brake lining carrier is known in prior art, for example in connection with disc brakes of vehicles, and in combination with a brake pad attached thereto, it forms a brake shoe. The brake shoe is connectible to a brake caliper via a brake lining carrier. The brake caliper is comprised of at least one piston via which the brake shoe is movable towards the brake disc of a disc brake. During a braking process, the brake lining carrier serves for transferring shear forces from the brake pad to the brake caliper, said shear forces being generated by the contact between the brake pad and the brake disc. On account of the great mass, in particular of utility vehicles like for example trucks and due to the high braking forces thereby required on braking, requirements posed for brake lining carriers and brake shoes equipped therewith are high in terms of their inherent stability. Therefore, brake lining carriers require high flexural rigidity to protect them from deformation and/or fracturing.

It is known from prior art to produce brake lining carriers in a casting process, as shown for example in DE 195 32 019 C1 and DE 103 50 725 A1. Furthermore known from DE 10 2004 014 858 A1 and DE 20 2005 011 660 U1 are brake lining carriers punched out from steel plates as well as rolled brake lining carriers which are disclosed in DE 103 00 585 B3.

Known from DE 10 2004 054 012 A1 is a lining carrier which is produced by deep-drawing from a metal sheet. Compared to production in a casting process, production by deep-drawing has the benefit in that a post-treatment need not be done. Furthermore, a braking lining carrier produced by deep-drawing from a relatively thin plate has clearly less weight than a brake lining carrier produced in a casting process. This reduction in weight takes a positive effect on road behavior and fuel consumption of a vehicle equipped with such a brake lining carrier. Moreover, it should be noted that a brake lining carrier produced by casting features worse material properties than those existing with a brake lining carrier produced by deep-drawing. The material of brake lining carriers produced in a casting process is brittle. Under extreme conditions, this may cause the brake lining carrier to break apart.

In relation to hitherto utilized brake lining carriers made of steel it is to be stated that these carriers have a relatively high weight which is afflicted with the disadvantages outlined hereinabove. Moreover, it has been economical only to a a certain extent up to now fabricating brake lining carriers of steel because it calls for steel plates having a relatively high material thickness in order to assure the demanded and usual build-in dimensions.

To provide sufficient grip between a modern-type brake caliper and a brake shoe it is expedient providing material projections at the brake caliper serving as lean-to elements at certain positions at the edge of a brake lining carrier. These to material projections co-act with the shaping of the brake caliper so that shear forces occurring while braking can be well transferred from the brake lining carrier to the brake caliper. At the same time, a dissipation of shear forces imposed on a brake lining to the brake lining carrier should be ensured. Especially suitable for this purpose proved to be a shaping of the brake lining carrier in which a completely bordered deepening is configured at the brake lining carrier for accommodating the brake lining.

Up to now, production of a brake lining carrier having those features outlined hereinabove, i.e. material projections at the brake caliper and a bordered deepening at the brake lining is only feasible by means of casting processes.

Against this background it is the object of the present invention to provide a method for producing a brake lining carrier that is economical and in which those disadvantages outlined hereinabove are avoided.

Based on a method of the type specified hereinabove, this task is solved by upsetting the workpiece transversely, in particular perpendicularly, to the deep-drawing direction in order to create at least one material thickening at the edge, wherein the thickness of the material thickening thus generated is greater than the thickness of the starting material.

The invention is directed towards producing a brake lining carrier by means of deep-drawing of a metallic workpiece (e.g. a steel plate). As outlined before, the production process serves for creating a brake lining carrier having material properties that are improved compared to those of a brake lining carrier produced in a casting process. Moreover, the brake lining carrier produced in this manner does not require any post-treatment which is indispensable for a brake lining carrier produced according to a casting process. The inventive brake lining carrier can thus be produced in less time and at less cost than a brake lining carrier produced in a casting process.

By means of the inventive creation of a material thickness of a predefined measure at the edge, it is feasible to realize a shaping and functionality of the brake lining carrier which up to now have only been achievable with brake lining carriers produced by applying a casting process. The material thickening forms a material projection on the brake caliper side which, as has been described hereinabove, is provided at a suitable position at the edge of the brake lining carrier. The material thickening increases the strength of the brake lining carrier and expands its function. The material thickening forms a lean-to element that co-acts with the lean-to or guiding surfaces of the brake caliper. Shear forces occurring while braking can be reliably transferred via the lean-to element from the brake lining carrier to the brake caliper. In accordance with the present invention, it matters to ensure that the thickness of the generated material thickening is greater than the thickness of the starting material (e.g. that of the steel plate used). Thus it is feasible to utilize a starting material which is significantly thinner than the overall thickness of the finished brake lining carrier, without adversely affecting the form stability of the finished product. Usually, the material thickening will be by approx. 30-50% thicker than the starting material. Savings on cost and weight will be significant. Another essential benefit lies in that the brake calipers designed for conventional brake lining carriers can remain unchanged for use with the inventive brake lining carrier.

By implementing the inventive method, it is feasible to advantageously produce a brake lining carrier by deep-drawing which on the brake pad side features a deepening completely bordered by a protrusion and which on the brake caliper side features the material projections mentioned hereinabove.

According to the invention, the afore-mentioned advantages of brake lining carriers formed of metal sheet, viz. their good material property, are combined with the benefits of brake lining carriers produced in accordance with a casting process, viz. their optimal shaping. At the same time, the well known disadvantages are avoided.

By means of the inventive method, it is possible to configure, for example, two or more, in particular four, retention projections on the brake caliper side at the edge of the brake lining carrier which ensure sufficient lean-to surface, thus improving the hold of the brake lining carrier at the pertinent brake caliper and more particularly establishing a robust mechanical link between the brake caliper and the brake lining carrier. Two retention projections each serve for transferring forces in circumferential and radial direction from the brake lining carrier to the brake caliper.

In accordance with an advantageous embodiment of the present invention, the blank material by means of deep-drawing receives a through-position in form of a brake-pad sided deepening, the inner contour of which is adapted to the configuration of a brake pad applied onto the brake lining carrier. The deepening forms a supporting surface for the brake pad which is laid back versus a bordering of the deepening. Generating the deepening by means of deep-drawing thus serves for creating a take-up for accommodating the brake pad. The bordering of the deepening has an inner contour that is adapted to the shaping of the brake pad to be connected with the brake lining carrier. Preferably, the part of the brake pad facing the brake lining carrier can be inserted in a form fit connection into the deepening. An optimal connection between the brake lining carrier and the brake pad is thus established, absorbing, at least partly, in particular the shear forces imposed by the bordering of the deepening on the brake pad while braking, at least partly.

In accordance with a preferred embodiment of the present invention, the brake lining carrier on the brake pad sided surface of the bordering comprises at least one limiting protrusion or limiting deepening wholly or partly encompassing the deepening. It is the task of the limiting protrusion or limiting deepening to limit the extension of the brake pad in a direction parallel to the surface of the brake lining carrier. The bordering of the deepening serves for ensuring stability of the brake lining carrier and at the same time as supporting area for a tool with which the brake pad is applied onto the brake lining carrier. The material of the brake pad is thus applied as a mash in plasticized status by means of a tool onto the brake lining carrier and subsequently solidified. The material of the brake pad thus fabricated usually spreads beyond the rim of the deepening in a certain extent. The problem then posed lies in that the mash (in particular if it is a dry mash) “drifts” during solidification. It means the extension of the mash and thus the contour of the brake pad on the bordering of the deepening will vary. As a means for counteraction, the limiting protrusion or limiting deepening according to the present invention may be provided for. On the bordering, they expediently form a wall and/or trench wholly or partly encompassing the deepening to serve as a form fit means that efficiently limits a non-desired extension (“drifting”) of the brake pad in a direction parallel to the surface of the brake lining carrier. The limiting protrusion or limiting deepening may expediently be created by forming the band-shaped or plate-shaped workpiece. Preferably the limiting protrusion or limiting deepening have a basically V-shaped cross-section.

In accordance with another advantageous embodiment of the present invention, material spreading over the rim after deep-drawing is removed by punching to create the pre-defined outer contour. Creation of the outer contour by punching makes sense because only one tool is needed in this manner for the whole production on forming (deep-drawing, upsetting deformation) and cutting-out (punching). This topic will still be addressed further below.

It is furthermore proposed to form the workpiece during the upsetting deformation transversely to the deep-drawing direction at the same time in the direction of deep-drawing, too. Owing to the force imposed in the direction of deep-drawing while forming, the workpiece is clamped and fixed. A simultaneous force impact in deep-drawing direction and in a direction perpendicular thereto on the whole causes a flow of material of the workpiece in the desired shape (pre-defined by the relevant tool).

Another advantageous embodiment of the present invention provides for perforating the workpiece prior to the upsetting deformation or during the upsetting deformation transversely, in particular perpendicularly, to the deep-drawing direction at pre-defined places and/or providing it with at least one edge-sided recess to be provided at a pre-defined place. The recess may be an aperture at the brake lining carrier for a wear-and-tear indicator, for example. The work process of perforating and/or cutting-out can be utilized in this manner to reliably fix the workpiece at the tool during the upsetting deformation.

It is furthermore proposed that prior to punching, during punching or during deep-drawing, pad retention bolts be generated in the area of the deepening on the brake pad side. The pad retention bolts serve to further improve the grip between the brake lining carrier and the brake pad. Upon configuring the pad retention bolts in the area of the deepening, the pad retention bolts protrude in a pre-defined extent from the brake pad sided surface of the brake lining carrier and at such a brake lining carrier into destined recesses at the brake pad, if the brake pad is arranged as destined. A form fit anchoring of the brake pad at the brake lining carrier, at least in circumferential direction, is thus achieved. The pad retention bolts may have a circular or a polygonal cross-section. Preferably indentations are configured at the brake caliper sided surface of the deepening at those places where the pad retention bolts at the brake pad sided surface of the deepening are configured in form of elevations. The pad retention bolts are preferably configured in one piece with the remaining brake lining carrier and are generated in the area of the deepening by indenting a forming body into the material of the brake lining carrier.

The latter embodiment of the present invention primarily serves for providing a better grip of the brake pad at the brake lining carrier. It is known from prior art to provide bores at the brake lining carrier which the relevant anchoring studs of the brake pad engage into. At the same time, the brake pad is glued with the brake lining carrier. High temperatures occurring while braking, however, may entail burning of the adhesive used. In that case, the brake pad will only be retained at the brake lining carrier by the anchoring studs. As a result hereof, the brake pad might get loose and lift-off slightly from the brake lining carrier. In an extreme case, this may involve a tearing-off of the anchoring studs due to shear forces occurring while braking. Furthermore known from prior art are brake shoes in which holes are bored into the brake lining carrier that are filled-up with the brake pad mass when being pressed. Moreover it is known to configure other holding elements for holding the brake pad on the surface of the brake lining carrier. The retention elements are applied as additional parts on the brake lining carrier, for example in form of grates or pins welded on or sintered on. Conversely, with the inventive indenting of the forming body into the material of the workpiece in the area of the deepening to configure the pad retention bolts, a clearly simpler, less costly though efficient possibility for connecting the brake lining carrier with the brake pad is created.

Another object of the present invention is a brake lining carrier produced in accordance with the method described hereinabove. With this brake lining carrier, two or more (preferably four) retention protrusions in form of material thickenings are preferably arranged at the edge, with the retention protrusions taking the effect of holding the brake lining carrier at the brake caliper in circumferential direction and possibly in radial direction, too. This configuration has been adapted to brake calipers commonly used nowadays. In accordance with the invention, the retention protrusions are configured as one piece together with the remaining brake lining carrier, without the necessity of having to increase expenditure on material as required in prior art. By way of the arrangement of the retention protrusions, a particularly good grip of the brake lining carrier at brake calipers mostly used nowadays is warranted. Shear forces occurring while braking can be transferred very well by the brake lining carrier to the brake caliper.

The invention alternatively relates to a brake lining carrier which is fabricated by forming and punching a band-shaped or plate-shaped workpiece and which comprises a brake pad sided deepening (trough-positioning) encompassed by a bordering, the inner contour of said deepening being adapted to the shape of a brake pad to be connected to the brake lining carrier. Accordingly, retention protrusions are arranged at the rim of the brake lining carrier which as outlined hereinabove take the effect of holding and/or guiding the brake lining carrier at a brake caliper and which are welded, bolted or riveted to the workpiece. The retention protrusions for this purpose may be profiled pieces or plate strips made of steel which at the relevant places are connected to the deep-drawn workpiece.

The a.m. task is furthermore solved by a machining device which is comprised of a first workstation for deep-drawing of a band-shaped or plate-shaped workpiece in a direction perpendicular to the plane of the workpiece, a second workstation for upsetting deformation of at least one edge area of the workpiece to create an edge-sided material thickening in a direction transversely, in particular perpendicularly to the deep-drawing direction, as well as a third workstation for punching of the deep-drawn workpiece, with the workstations being arranged one behind the other. Such machining devices are also designated as combined progressive tools. The individual workstations are consecutively passed through by the workpiece, e.g. during successive work strokes of a relevant form press, with it being conceivable to implement different sequences in the arrangement of the workstations at the machining device. The machining device can be operated in such a manner that the workstations are active simultaneously and in parallel so that machining of several workpieces is performed at the same time. It should be noted that the number of workstations of the inventive machining device is not confined to three. Depending on applications, less or more steps of machining and thus a corresponding number of workstations may make sense.

In an advantageous embodiment of the present invention, the second workstation comprises at least one upsetting deformation slider working transversely to the deep-drawing direction as well as at least one pocket which the workpiece material displaced by the upsetting deformation slider flows into. On account of the upsetting deformation, the desired edge-sided material thickenings are created. The appropriately shaped pockets of the machining device are provided for controlling their dimensions and shape.

The second workstation advantageously comprises means for perforating and/or edge-sided machining of the blank. The edge-sided machining of the blank may serve, for example, for creating a recess in which a wear-and-tear indicator of the disc brake can be arranged later-on.

The third workstation or the second workstation preferably comprises means for configuring brake pad sided pad retention bolts. Thus the second or third workstation can simultaneously perform the production of the brake pad retention bolts in one step of work.

Further advantages and features of the present invention are elucidated more closely in the following by way of practical examples illustrated in the figures, where:

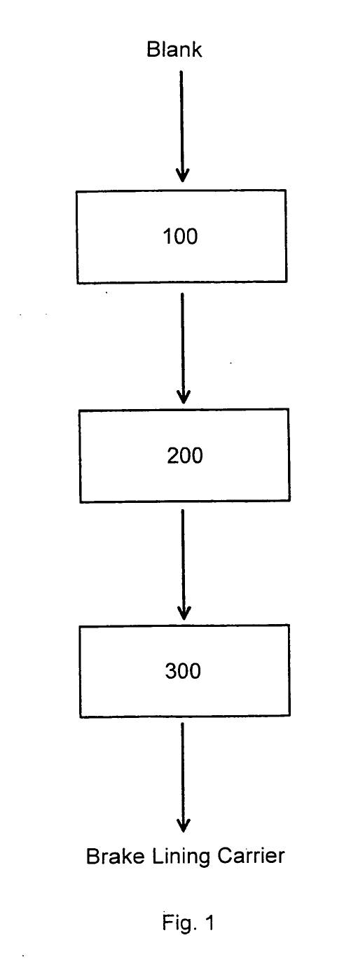

FIG. 1: shows a schematic view of the inventive method in form of a block diagram,

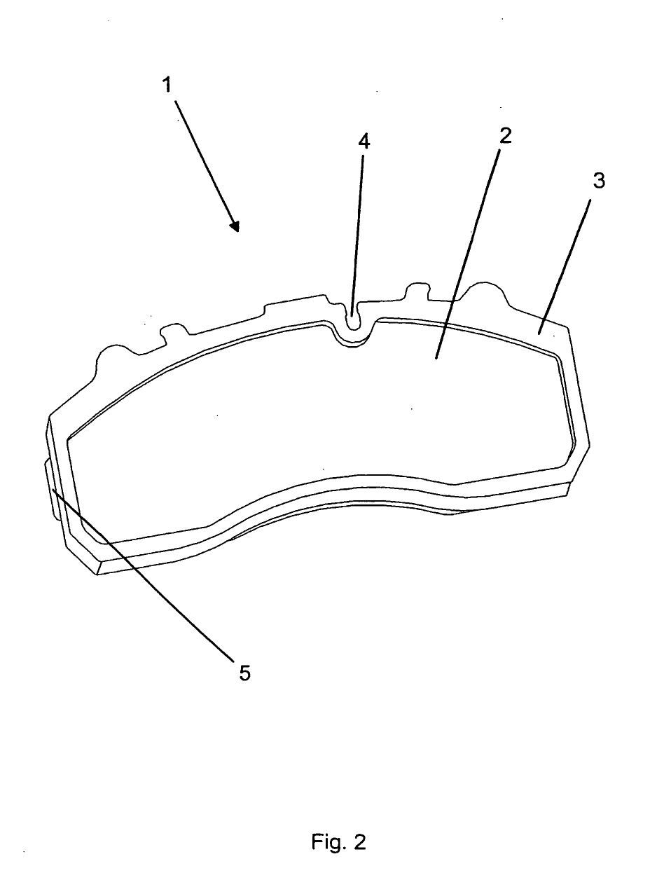

FIG. 2: shows a perspective view of a practical example of an inventive brake lining carrier,

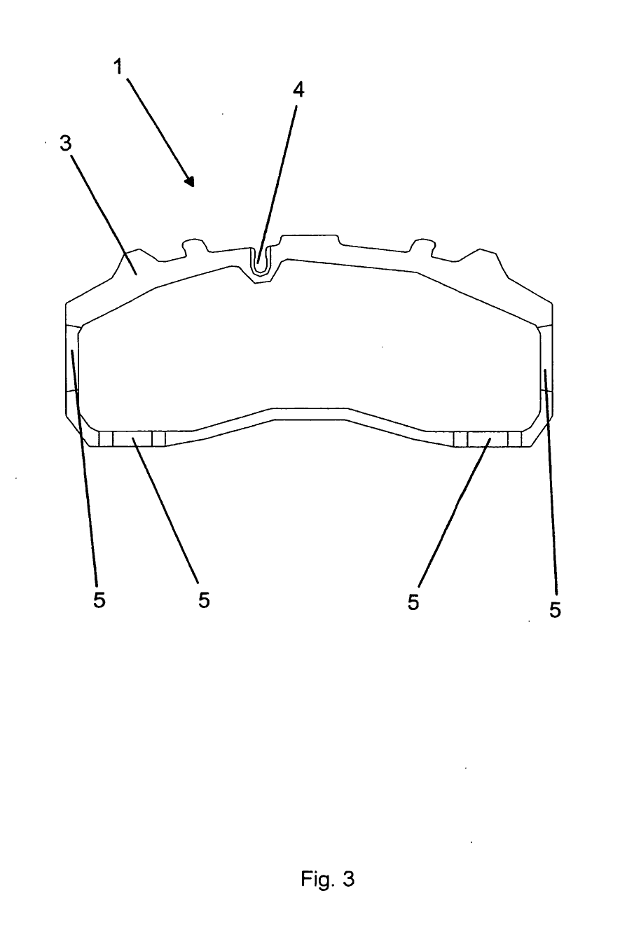

FIG. 3: shows another view of the brake lining carrier illustrated in FIG. 2,

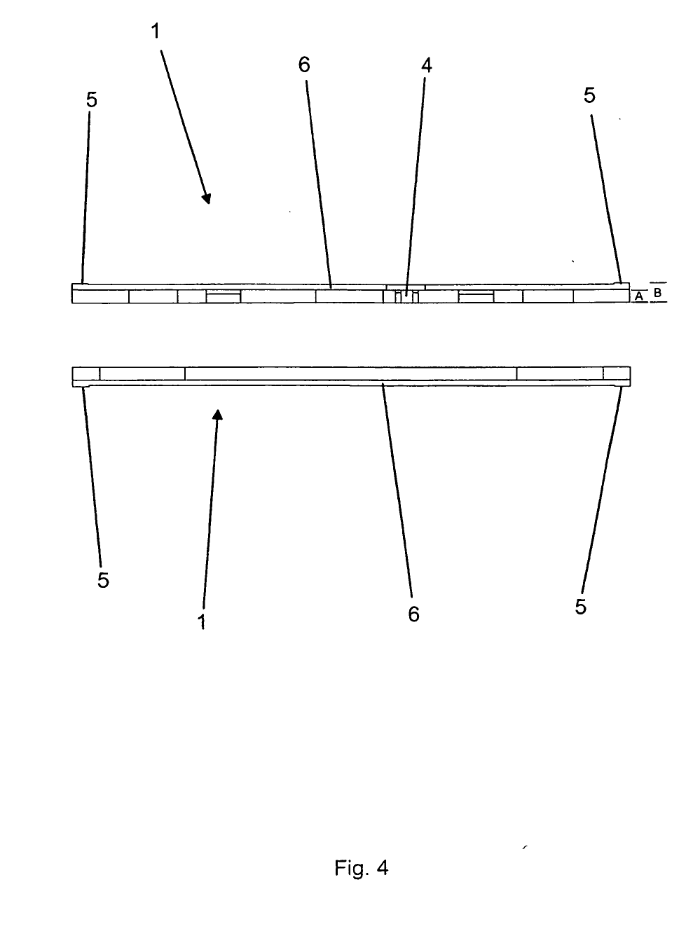

FIG. 4: shows another two views of the brake lining carrier illustrated in FIGS. 2 and 3,

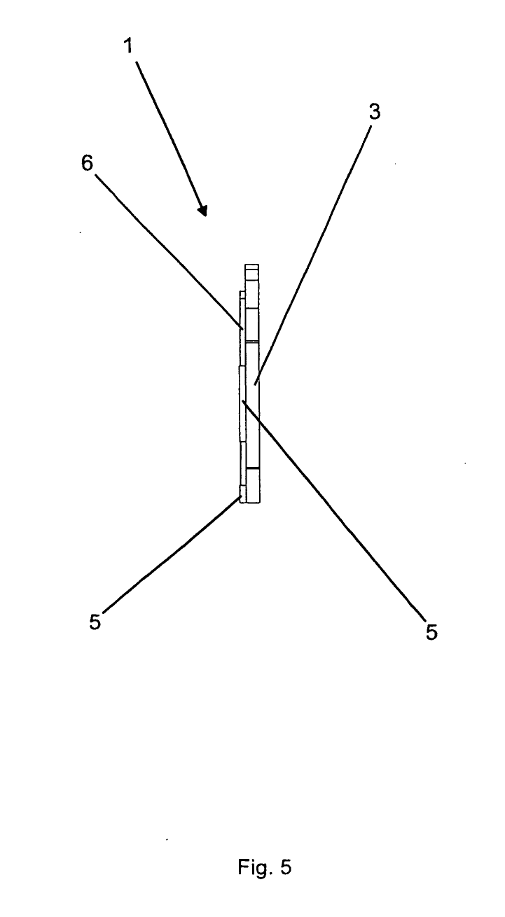

FIG. 5: shows another view of the brake lining carrier illustrated in FIGS. 2 and 3,

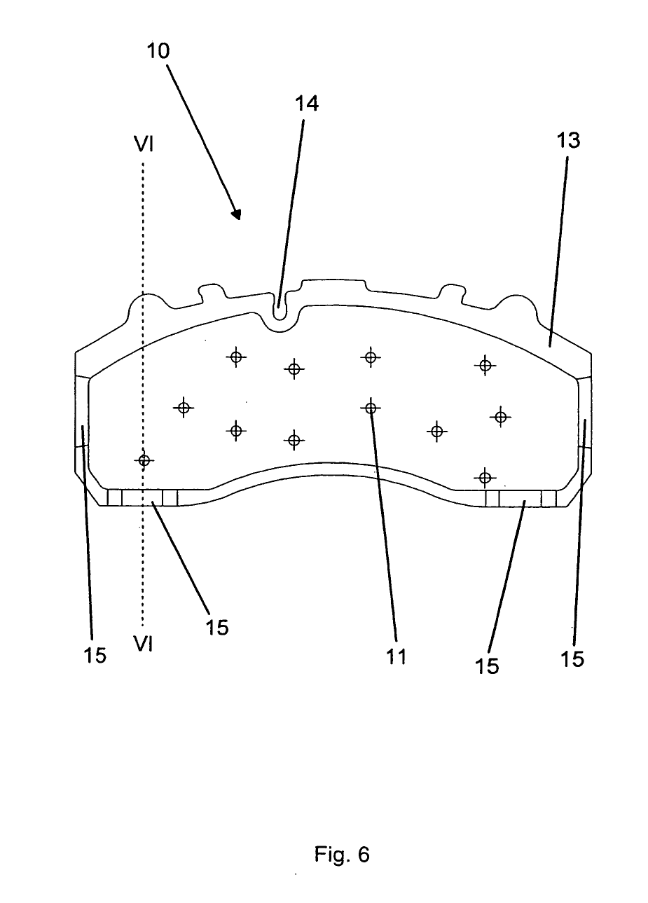

FIG. 6: shows a view of an alternative practical example of the inventive brake lining carrier,

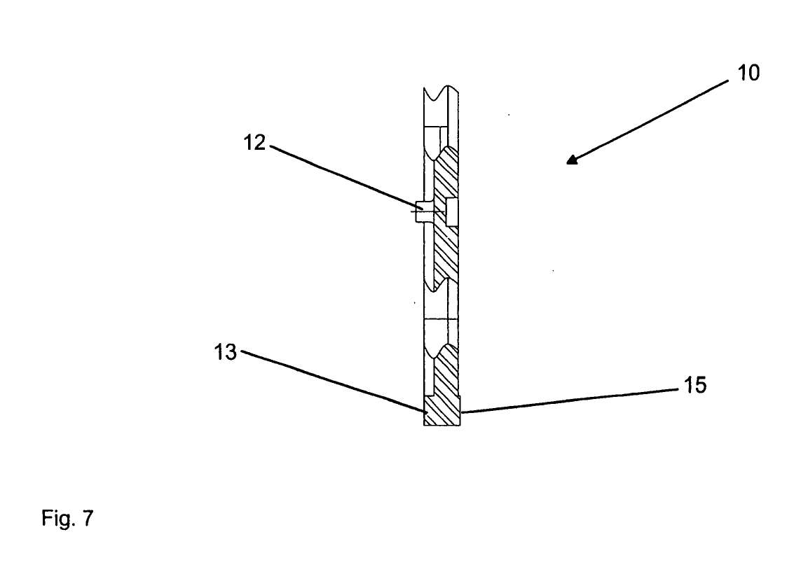

FIG. 7: shows a partial cross-section through the brake lining carrier illustrated in FIG. 7 along the line VI-VI in FIG. 6, and

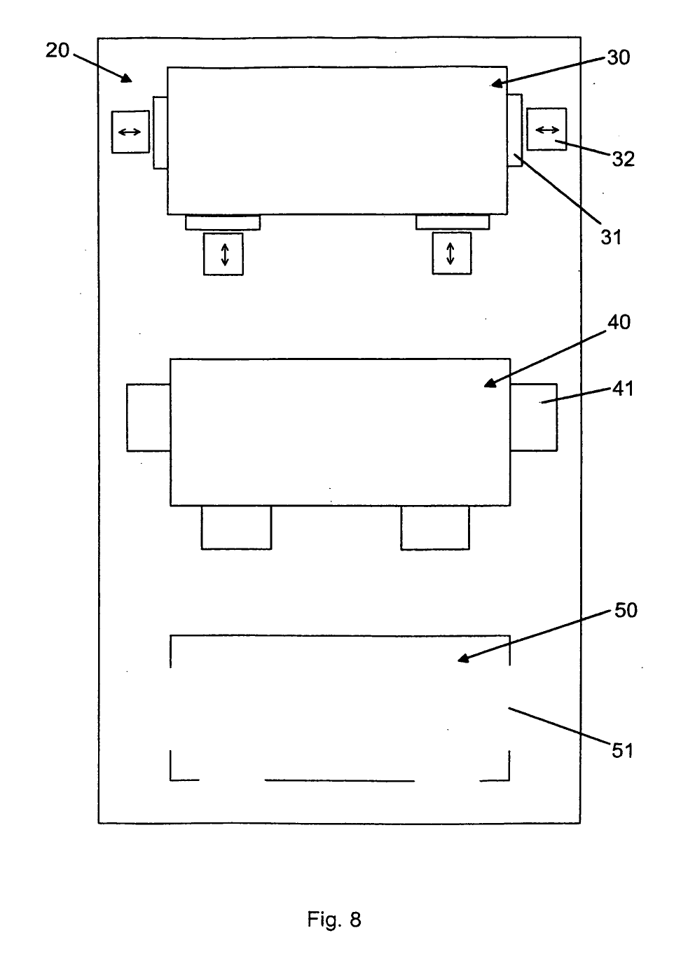

FIG. 8: shows a schematic view of an inventive machining device, viz. a top view on a machining base part of a forming tool for use in a forming press (machining top part is not shown here),

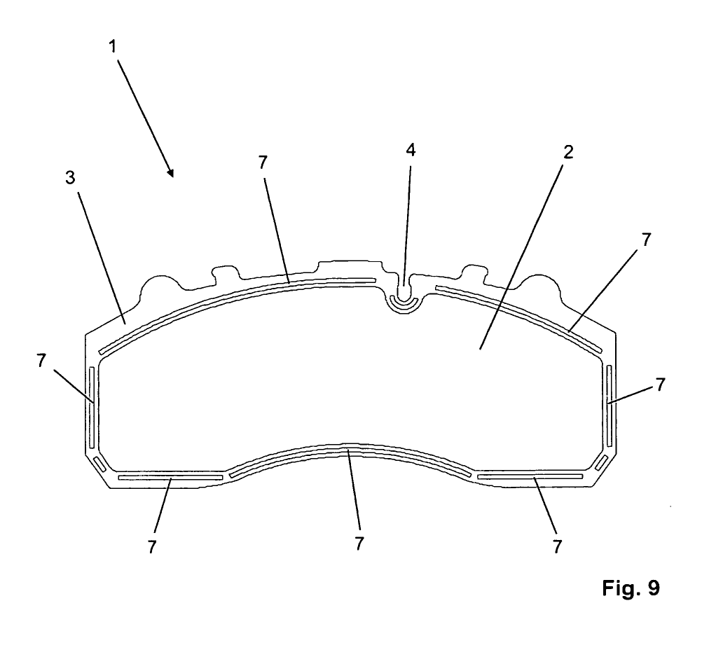

FIG. 9: shows another practical example of an inventive brake lining carrier.

In accordance with the practical example shown in FIG. 1, a blank made of steel plate is initially furnished to serve as workpiece. In process step 100 of the workstation 30, this blank is fed forward in horizontal direction of work (in FIG. 8 in the drawing plane) for upsetting deformation of an edge section of the blank, i.e. to generate an edge-sided material thickening of a pre-defined extent. FIG. 8 schematically shows the arrangement of the workstation 30 at the machining base part 20 of the machining device. By means of the workstation 30, a section of the edge of the workpiece is upset in a direction transversely, in particular perpendicularly, to the deep-drawing direction (perpendicularly to the drawing plane). At the same time, the workpiece is perforated at pre-defined places and provided with an edge-sided recess to be provided at a pre-defined place which serves for the arrangement of a wear-and-tear indicator (not depicted in FIG. 8).

There are four pockets 31 arranged at the machining base part 20 in the area of the workstation 30 to take-up the material displaced during the upsetting deformation. Four upsetting deformation sliders 32 are provided for, their directions of work being indicated by arrows.

Next to process step 100, process step 200 is executed which is performed by means of workstation 40. The workpiece is further transported between two working strokes of the forming press from workstation 30 to workstation 40. By means of workstation 40, the pre-perforated and upset workpiece is deep-drawn in a direction perpendicular to the plane of the workpiece. Hereby configured is a brake lining sided deepening whose inner contour is adapted to the shape of a relevant brake pad. The deepening is particularly recognizable in FIGS. 2, 3 and 6 (see further below).

Again arranged at the machining base part 20 of the machining device in the area of the workstation 40 are pockets 41 for taking-up the material from the edge-sided material thickenings generated by upsetting deformation in the preceding process step. The pockets 41 serve for further forming of the edge-sided material thickenings during the deep-drawing process. Workstation 40 may furthermore comprise means for configuring brake lining sided lining retention bolts (not shown in FIG. 8).

Upon machining of the workpiece in process step 200, the workpiece passes through process step 300 by means of workstation 50 which serves for punching the deep-drawn workpiece. Workstation 50 serves for removing surplus material existing after deep-drawing at the edge to generate a pre-defined outer contour of the blank by punching or fine cutting.

In the area of workstation 50, i.e. in the area of the upset edge sections of the workpiece, the machining base part 20 has recesses 51 to accommodate four (as shown in this practical example) retention protrusions at the edge of the brake lining carrier. The positioning of the recesses 51 corresponds to that of the pockets 31 and 41 of the workstations 30 and 40.

Finally, upon passing through workstations 30, 40, and 50, a brake lining carrier ready for finishing is delivered by the machining device.

FIG. 2 shows a perspective representation of a practical example of the inventive brake lining carrier 1. To be seen here is the side of the brake lining carrier 1 that faces a brake pad not shown here. The brake lining carrier 1 comprises a deepening 2 whose inner contour is adapted to the shape of the brake pad. Shear forces evolving on braking between the brake lining and the brake lining carrier 1 can be taken-up by the bordering 3 of the deepening 2 (at least partly). At the upper side of the bordering 3 of the brake lining carrier 1, an edge-sided recess 4 is arranged in which a wear-and-tear indicator not shown here can be arranged. On the brake caliper side, there are four retention protrusions 5 arranged at the brake lining carrier 1, thereof only one being recognizable in FIG. 2. Their shape and positioning is adapted to the configuration of the pertinent brake caliper, thus ensuring good grip and good force transmission between brake lining carrier 1 and brake caliper, i.e. both in circumferential and in radial direction.

FIG. 3 shows the brake lining carrier 1 illustrated in FIG. 2 from a brake caliper sided perspective. The four retention protrusions 5 and their exact positioning can be seen. The retention protrusions 5 are arranged at the edge of the brake lining carrier 1, more particularly at the brake caliper sided surface in the area of the bordering 3 of the deepening 2.

FIG. 4 in its upper half shows a view of the brake lining carrier 1 from FIGS. 2 and 3 from above. It can be seen that on configuring the deepening 2 shown in FIG. 2, a corresponding brake caliper sided buckling 6 is created at the brake lining carrier 1. The retention protrusions 5 follow next to this buckling 6 at the left and right side. In its lower half, FIG. 4 depicts the brake lining carrier 1 shown in FIG. 2 from below. Here, too, one can see the buckling 6.

In FIG. 4 in the upper view, the material thickness of the starting material is designated by A. In the practical example, it accounts for 6 mm. The material thickness generated by upsetting deformation in the area of the retention protrusions 5 is designated by B. In the practical example, it accounts for 9 mm. Thus the material thickness in the area of the retention protrusions 5 is greater than the material thickness of the starting material.

FIG. 5 shows a lateral view of the brake lining carrier 1 illustrated in FIGS. 2 and 3.

FIG. 6 depicts an alternative practical example of the inventive brake lining carrier 10 from a brake caliper sided view. The brake lining carrier 10 basically corresponds with the brake lining carrier 1 shown in FIGS. 2 to 5, except for the lining retention bolts 12 arranged on the brake lining carrier 10 which are configured when the workpiece is deep-drawn. At those places where the lining retention bolts 12 are arranged at the brake lining in the area of the deepening, indentations 11 are arranged on the brake caliper.

As depicted in FIG. 7, the lining retention bolts 12 have been created by indentation of a forming body, proceeding from the side of the brake lining carrier 10 that faces the brake caliper. Besides, the brake lining carrier 10 comprises retention protrusions 15, a bordering 13 of the deepening provided for the brake pad as well as an edge-sided recess 14 for the afore-mentioned purpose.

With the practical example illustrated in FIG. 9, the brake lining carrier 1 on the brake lining sided surface of the bordering 3 comprises at least one limiting protrusion 7 wholly or partly enclosing the deepening 2, said limiting protrusion having the shape of a wall discontinuously encompassing the deepening 2. The course of the limiting protrusion 7 follows the edge contour of the deepening 2. Owing to the limiting protrusion 7, which for example is V-shaped in its cross-section, the extension of the (not depicted) brake pad in a direction in parallel to the surface of the brake lining carrier 1 is limited. The material of the brake pad spreads beyond the edge of the deepening 2 in a certain extent so that the limiting protrusion 7 forms a form fit means that attacks the brake pad in the area of the bordering 3. The limiting protrusion 7 prevents a non-desired extension (“drifting”) of the brake pad in the direction in parallel to the surface of the brake lining carrier 1 and thus it warrants contour stability of the brake pad during production.

The practical examples described based on these figures serve explanatory purposes and are not meant to be restrictive.

1. Method for producing a brake lining carrier (1, 10), in particular for a disc brake of a vehicle, wherein a band-shaped or plate-shaped workpiece is deep-drawn in a direction perpendicular to the plane of the workpiece, wherein
in order to create at least one material thickening at the edge, the workpiece is upset transversely, in particular perpendicularly, to the deep-drawing direction, wherein the thickness of the material thickening thus generated is greater than the thickness of the starting material.

2. Method according to claim 1, wherein by deep-drawing the workpiece receives a brake-pad sided deepening (2) encircled by a bordering (3), the inner contour of which is adapted to the shape of a brake pad to be connected with the brake lining carrier (1, 10).

3. Method according to claim 2, wherein at least one limiting protrusion (7) or a limiting deepening are provided on the brake pad sided surface of the bordering (3).

4. Method according to claim 3, wherein the limiting protrusion (7) or the limiting deepening are generated by forming the band-shaped or plate-shaped workpiece.

5. Method according to claim 3, wherein the limiting protrusion (7) or the limiting deepening have a mainly V-shaped cross-section.

6. Method according to claim 1, wherein material spreading beyond the edge after deep-drawing is removed by punching to generate a pre-defined outer contour.

7. Method according to claim 1, wherein during upsetting transversely to the deep-drawing direction the workpiece is simultaneously formed in the direction of deep-drawing.

8. Method according to claim 1, wherein prior to punching or during punching the workpiece is perforated transversely, in particular perpendicularly to the deep-drawing direction at pre-defined places and/or provided with at least one edge-sided recess (4, 14) to be provided at a pre-defined place.

9. Method according to claim 1, wherein prior to punching, during punching or during deep-drawing, lining retention bolts (12) are generated in the area of the deepening at the brake pad.

10. Brake lining carrier (1, 10), in particular for a disc brake of a vehicle, wherein
it is produced in accordance with the method pursuant to claim 1.

11. Brake lining carrier (1, 10) according to claim 10, wherein two or more retention protrusions (5, 15) in form of material thickenings are arranged at the edge of the brake lining carrier (1, 10), wherein the retention protrusions (5, 15) effect the holding and/or guidance of the brake lining carrier (1, 10) at a brake caliper.

12. Brake lining carrier (1, 10), in particular for a disc brake of a vehicle, with the brake lining carrier being produced by forming and punching of a band-shaped or plate-shaped workpiece and being comprised of a brake pad sided deepening (2) encircled by a bordering (3), the inner contour of said deepening being adapted to the shape of a brake pad to be connected with the brake lining carrier (1, 10), comprising
retention protrusions (5, 15) arranged at the edge of the brake lining carrier (1, 10), wherein the retention protrusions (5, 15) effect the holding and/or guidance of the brake lining carrier (1, 10) at a brake caliper, and with the retention protrusions (5, 15) being welded, bolted, or riveted to the workpiece.

13. Brake lining carrier according to claim 12, wherein on the brake pad sided surface of the bordering (3) at least one limiting protrusion (7) or a limiting deepening are arranged that limit the extension of the brake lining in the direction in parallel to the surface of the brake lining carrier (1, 10).

14. Brake lining carrier according to claim 13, wherein the limiting protrusion (7) or the limiting deepening have a mainly V-shaped cross-section.

15. Machining device, in particular a forming tool, for executing the method according to claim 1, said device comprised of a first workstation (40) for deep-drawing of a band-shaped or plate-shaped workpiece in a direction perpendicular to the plane of the workpiece, and comprised of a second workstation (30) for upsetting at least one edge-sided material thickening in a direction transversely, in particular perpendicularly, to the deep-drawing direction, as well as comprised of a third workstation (50) for punching the deep-drawn workpiece, with the said workstations (30, 40, 50) being arranged one behind the other.

16. Machining device according to claim 15, wherein the second workstation (30) is comprised of at least one upsetting deformation slider (32) working transversely to the deep-drawing direction as well as at least one pocket (31) which the workpiece material displaced by the upsetting slider (32) flows into.

17. Machining device according to claim 16, wherein the second workstation (30) is comprised of means for perforating and/or edge-sided machining of the workpiece.

18. Machining device according to claim 15, wherein the third workstation (50) or the second workstation (40) is comprised of means for forming brake pad sided lining retention bolts (12).
